(19) United States
(12) Patent Application Publication
(10) Pub. No.: US 2009/0081609 A1
(43) Pub. Date: Mar. 26, 2009

(54) DISPOSABLE PROPHY ANGLE GRIP

(75) Inventors: Russell Glen Kalbfeld, Naperville, IL (US); Richard Gross, Wheaton, IL (US); Randy Soibel, Chicago, IL (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Sunstar Americas, Inc., Chicago, IL (US)

(21) Appl. No.: 11/860,310

(22) Filed: Sep. 24, 2007

(51) Int. Cl. A61C 3/06

(52) U.S. Cl. 433/125; 433/166

(57) ABSTRACT

A disposable prophy angle for mounting on a powered dental handpiece with an elastomeric grip where the elastomer of the grip is disposed along the back of the neck, the back of the shoulder, and about the base of the device so that the prophy angle may be comfortably grasped by the fingers and thumb of a user, so that it will resist slippage from the user's hand, and so that it will tactilely direct the user's fingers and thumb into the proper position to handle the prophy angle in an effective manner.

### FIELD OF THE INVENTION

This invention relates generally to disposable prophy angles designed to be mounted on powered dental handpieces, and more particularly, to prophy angles having grips that enable the prophy angles to be comfortably grasped by the fingers and the thumb of the dental professional using it, which resist slippage, and which tactilely direct the user's fingers and thumb into the proper position to handle the prophy angle in an effective manner.

### BACKGROUND OF THE INVENTION

Modern dental prophylaxis includes the removal of deposits and stains from the teeth by scaling and polishing. The principal purpose of polishing the teeth is to remove plaque and stain and to make the surfaces smooth so that it is more difficult for plaque and debris to attach and accumulate. In the polishing step, typically a polishing paste is applied using a powered prophy device such as a prophy angle with an attached elastomeric prophy cup.

A conventional prophy angle is typically attached to an appropriate powered dental handpiece so that a drive gear of the dental handpiece meshes with corresponding gearing in the prophy angle to rotate an elastomeric cup mounted in the head of the device. The rotating elastomeric cup is used in tooth cleaning and polishing procedures.

Disposable prophy angles made of suitable rigid plastic materials are widely available. They are mass produced and therefore very economical.

In order to ensure optimal control of a prophy angle in the close space of a patient's mouth, it is desirable to hold the prophy angle with the thumb and fingers gripping the body of the device, rather than the handpiece to which it is mounted. Unfortunately, however, dental professionals unconsciously tend to grip the handpiece instead, foregoing the optimal hand placement. This may be due to a number of reasons, including more noticeable and uncomfortable vibration in the prophy angle than in the handpiece that drives it, slipperiness of the hard plastic surface of the prophy angle, (particularly as it accumulates moisture during use), or a lack of tactile consciousness regarding where the gripping is actually maintained while the dental prophylaxis proceeds.

Thus, a disposable prophy angle that could be comfortably grasped by the fingers and the thumb of the dental professional using it, which would resist slippage, and which would tactilely direct the user's fingers and thumb into the proper position to handle the prophy angle more effectively would constitute an important contribution to the art.

### SUMMARY OF THE INVENTION

The present invention relates to a prophy angle for mounting on a powered dental handpiece with a grip of the prophy angle to be comfortably grasped by the fingers and thumb of the user. The grip not only resists slippage, it also tactilely directs the user's fingers and thumb into the proper position to handle the prophy angle in an effective manner. The prophy angle includes a head and body, the body including a neck, a shoulder and a base and a prophy cup rotatably mounted to the front of the head. An elastomeric neck portion runs along the back of the neck, an elastomeric shoulder portion runs along the back of the shoulder, and an elastomeric base portion running about the base.

### BRIEF DESCRIPTION OF THE DRAWINGS

The foregoing objects, advantages and features of the present invention will be apparent from the following detailed description and the accompanying drawings, in which like referenced numerals have been used to designate like or similar elements, and in which:

FIG. 1 is a perspective view of a prophy angle in which the device is provided with an elastomeric gripping surface in accordance with the present invention;

FIG. 2 is a side elevation view of the device of FIG. 1;

FIG. 3 is another side elevation view of the device of FIG. 1, in which the elastomeric gripping surface has been removed in order to illustrate the cavity into which the elastomer is molded;

FIG. 4 is a partial end perspective view of the prophy angle of the present invention; and

FIG. 5 is a perspective view of the device of FIG. 1 gripped by the hand of a dental professional about to begin a tooth polishing procedure.

### DETAILED DESCRIPTION OF A PREFERRED EMBODIMENT

Turning now to the Figures, a prophy angle 10 in accordance with the present invention is shown. The prophy angle includes a head 12 and a body 14. Body 14 includes a neck 16, a shoulder 18 and a base 20. The prophy angle is molded from an appropriate rigid resin such as polypropylene, polyethylene, acetyl, acrylontrile-butadiene-styrene (ABS), or nylon. Among these, ABS is currently preferred.

An elastomeric prophy cup 22 is rotatably mounted to the front of head 12 such that the major axis of the prophy cup intersects the major axis of the head and these axes are generally perpendicular to the major axis of body 14 of the device.

Rotation of the prophy cup is achieved by a mechanism including a drive gear disposed within the head and body of the device. This drive mechanism is of conventional design and is not shown in the figures, but for a protruding portion of the drive 24 which will engage the powered dental handpiece so that the dental handpiece can rotate the drive gear to produce the desired rotation in the prophy cup.

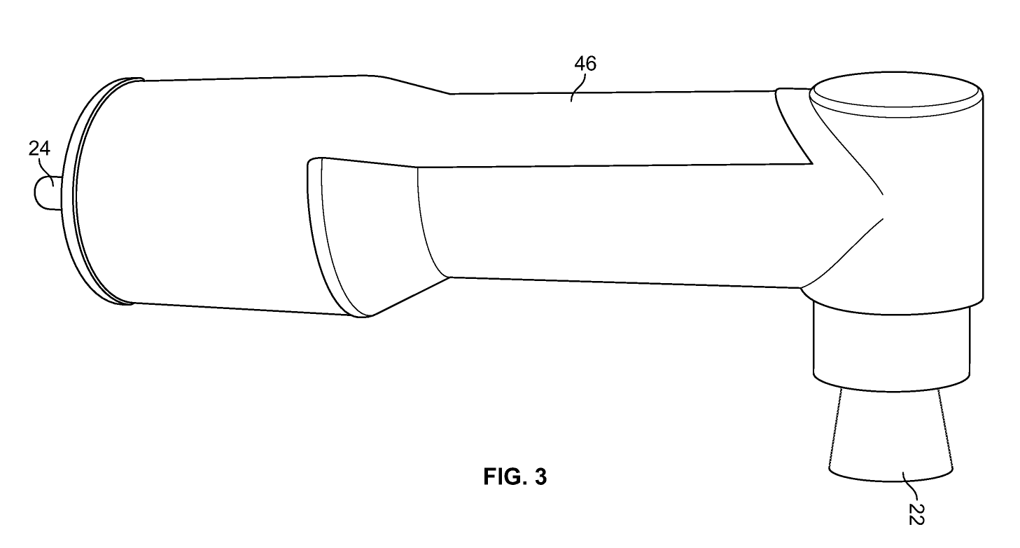

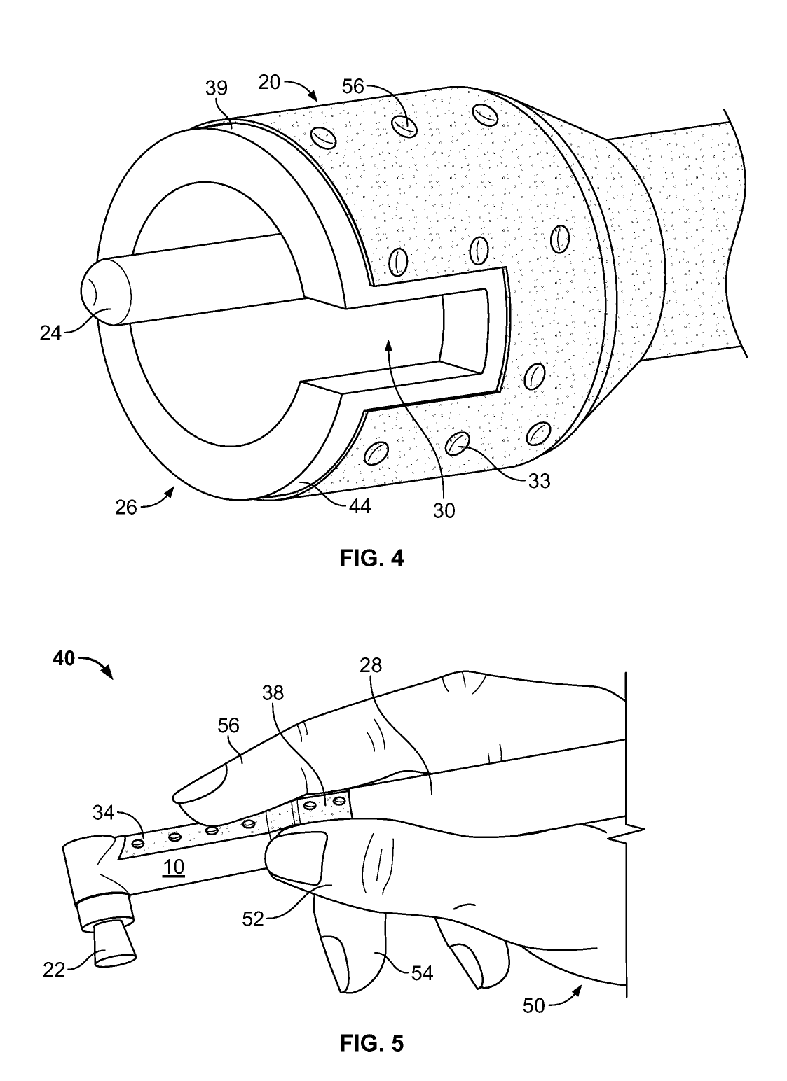

The distal end 26 of base 20 is generally circular and dimensioned so that its inner diameter will fit snugly upon the handpiece 28 (FIG. 3). Distal end 26 also includes a notch 30 configured to receive a protruding portion on the handpiece (not shown) to insure that the prophy angle is mounted on the handpiece in the appropriate orientation.

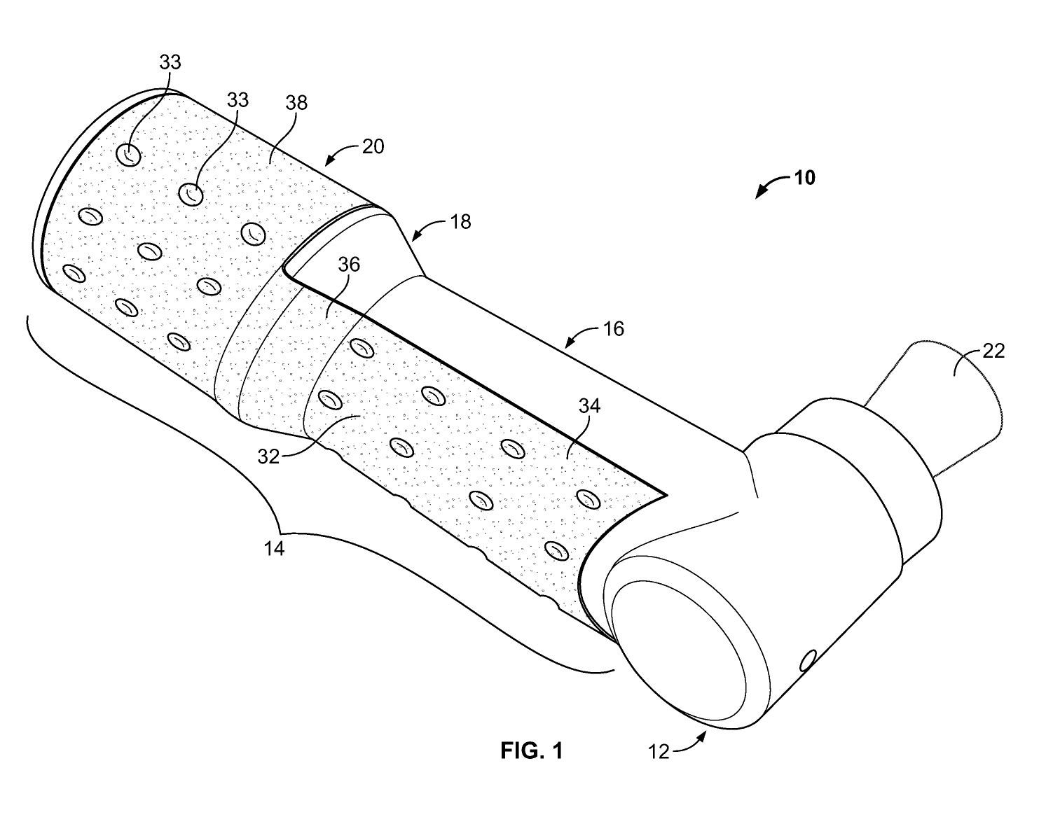

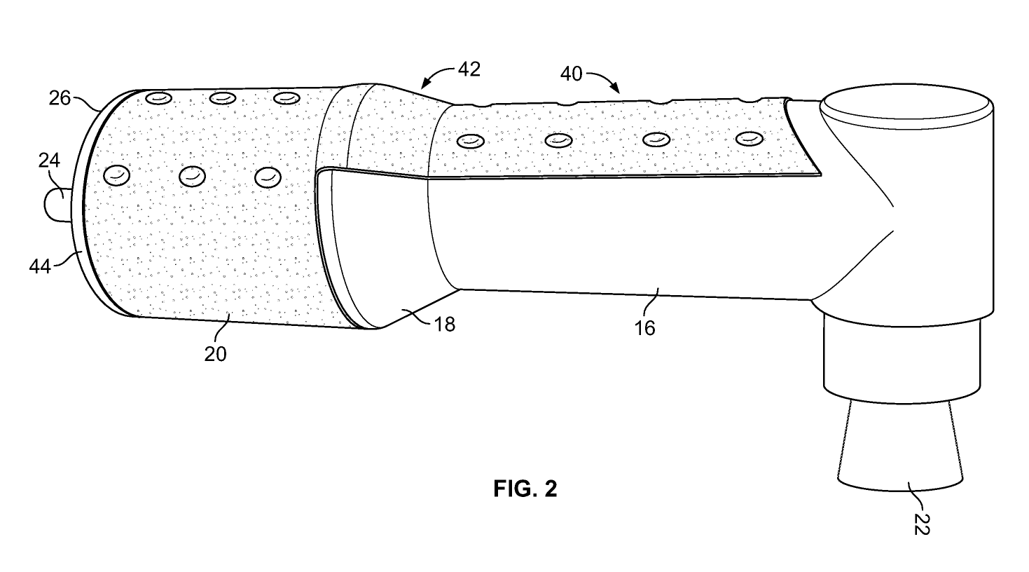

Prophy angle 10 includes an elastomeric overmolded area 32. Overmolded area 32 generally comprises three portions: an elastomeric neck portion 34, an elastomeric shoulder portion 36 and an elastomeric base portion 38. The elastomeric neck portion runs along the back 40 of neck 16, generally opposite the front of the head to which cup 22 is mounted. The elastomeric shoulder portion runs along the back 42 of shoulder 18, also generally opposite the front of the head to which cup 22 is mounted. Finally, the elastomeric base portion 38 extends about the circumference of the base 20 of the prophy angle. The elastomer of the base, however, stops short of the distal edge of the angle and the edge of notch 30 to establish a rigid perimeter 44 to insure that the rigid resin material of the prophy angle rather than the elastomer will engage handpiece 28. Preferably, the overmolded area will be generally continuous as illustrated in FIGS. 1 and 2.

Preferred elastomers used in elastomeric overmolded area 32 will chemically bond to the rigid base member and include urethanes, styrene-ethylene-butylene-styrene or SEBS elastomers (e.g. Kraton or Dynaflex, available from GLS Corporation of Cary, Ill., and metallocene elastomers (e.g., Engage, available from DuPont Dow Elastomers, L.L.C. of Freeport, Tex.) and fully vulcanized ethylene-propylene-diene-monomers in a continuous matrix of polypropylene (e.g., Santoprene, available from Advanced Elastomer Systems, L.P., of Akron, Ohio). Among these, Dynaflex is presently preferred. It is preferred that the elastomer have a Shore A hardness of less than about 60, and preferably a Shore A hardness in the range of about 5-45. Presently, a Shore A hardness of about 40 is most preferred.

In FIG. 2 the rigid base member of the prophy angle is shown with a uniform depression 46 to receive the overmolded elastomer. Thus, the elastomeric material is selectively overmolded onto the rigid base member using conventional molding techniques, such as conventional injection molding. The thickness of the elastomer should be sufficient to produce a tactile sense of softness while not producing flash outside of the contours of the depression or interfering with the adherence of the elastomer within the depression. For example, an elastomer thickness of about 0.60 inches has been found to meet this criteria.

Operation of the prophy angle of the present invention may be best understood by reference to FIG. 5. In this figure, prophy angle 10 is shown mounted to the distal end of dental handpiece 28 which is arranged to drive the prophy cup in a rotary fashion, as described earlier, with the dental professional holding the dental handpiece in his or her hand 50. Most importantly, the dental professionals' thumb 52 and middle finger 54 are abutting and grasping elastomeric base portion 38 with the pad of the thumb against elastomeric shoulder portion 36 while the pad of the dental professional's forefinger 56 rests against elastomeric neck portion 34.

The elastomeric overmolded areas dampen the transmission of vibration from the prophy angle to the user's fingers and hand, making the device more comfortable to use than current hard plastic prophy angles. Also, in a preferred embodiment, dimples 56 will be formed in the surface of the elastomeric portions to enhance these effects. Most importantly, the disposition of the elastomeric surfaces guides the dental professional's fingers into the optimal position on the prophy angle as the differing surface textures and resilience of the elastomeric areas and the hard plastic areas are picked up tactically as the device is handled. This insures that the dental professional's fingers will be up high on the prophy angle where the greatest force and dexterity of manipulation can be maintained, to facilitate the most efficient and effective polishing and cleaning by the prophy cup.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A prophy angle for mounting on a powered dental hardpiece with a grip to be comfortably grasped by the fingers and thumb of the user to tactilely direct the user's fingers and thumb into the proper position to handle the prophy angle in an effective manner comprising:
a head and a body supporting the head, the body including a base, a shoulder and a neck;
a prophy cup rotatably mounted to the front of the head;
an elastomeric neck portion running along the back of the neck;
an elastomeric shoulder portion running along the back of the shoulder; and
an elastomeric base portion running about the base.

2. The prophy angle of claim 1 in which the prophy angle is molded from a rigid resin chosen from the group consisting of polypropylene, polyethylene, acetyl, acrylonitrile-butadene-styrene, and nylon.

3. The prophy angle of claim 1 in which the prophy angle is molded from acrylonitrile-butadene-styrene.

4. The prophy angle of claim 1 in which the prophy cup is elastomeric and rotatably mounted to the head so that the major axis of the prophy cup intersects the major axis of the head and these axes are generally perpendicular to the major axis of the prophy angle.

5. The prophy angle of claim 1 in which the distal end of the base is generally circular dimensioned so that its inner diameter will fit snuggly upon the handpiece, the distal end including a notch configured to receive a protruding portion on the handpiece to ensure that the prophy angle is properly oriented on the handpiece.

6. The prophy angle of claim 5 in which the base includes a rigid perimeter below the elastomeric base portion for engaging the powered handpiece.

7. The prophy angle of claim 1 in which the base is generally circular and the elastomeric base portion extends about the entire circumference of the base.

8. The prophy angle of claim 1 in which the elastomer is chosen from the group consisting of urethanes, styrene-ethylene-butylene-styrene, metallocene, elastomers and fully vulcanized ethylene-propylene-diene-monomers in a continuous matrix of polypropylene.

9. The prophy angle of claim 1 in which the elastomer is a styrene-ethylene-butylene-styrene resin.

10. The prophy angle of claim 1 in which the elastomer has a Shore A hardness of less than about 60.

11. The prophy angle of claim 1 in which the elastomer has a Shore A hardness of about 5-45.

12. The prophy angle of claim 1 in which the elastomer has a Shore A hardness of about 40.

13. The prophy angle of claim 1 in which the prophy angle includes a rigid base member with a depression for overmolding the elastomeric portions.

14. The prophy angle of claim 1 in which the thickness of the elastomeric portions is about 0.60 inches.

15. The prophy angle of claim 1 in which the elastomeric neck portion, the elastomeric shoulder portion, and the elastomeric base portion comprise a generally continuous overmolded area.

16. The prophy angle of claim 1 including dimples in the elastomeric portions.

17. A prophy angle for mounting on a powered dental handpiece with a grip of the prophy angle to be comfortably grasped by the fingers and thumb of the user, that resists slippage, and that tactilely directs the user's fingers and thumb into the proper position to handle the prophy angle in an effective manner comprising:
a head and a body, the body including a neck, a shoulder and a base;
an elastomeric prophy cup rotatably mounted to the front of the head; and
a generally continuous elastomeric overmolded area including an elastomeric neck portion, an elastomeric shoulder portion, and an elastomeric base portion,
the elastomeric neck portion running along the back of the neck,
the elastomeric shoulder portion running along the back of the shoulder, and
the elastomeric base portion running about the base.

18. The prophy angle of claim 17 in which the elastomer of the elastomeric overmolded area has a Shore A hardness of less than about 60.

19. A prophy angle for mounting on a powered dental handpiece with a grip of the prophy angle to be comfortably grasped by the fingers and thumb of the user, that resists slippage, and that tactilely directs the user's fingers and thumb into the proper position to handle the prophy angle in an effective manner comprising:
a rigid base member having a head and a body, the body including a neck, a shoulder and a base;
an elastomeric prophy cup rotatably mounted to the front of the head;
a depression in the rigid base member for a generally continuous overmolded elastomeric neck portion, elastomeric shoulder portion, and elastomeric base portion,
the elastomeric neck portion running along the back of the neck,
the elastomeric shoulder portion running along the back of the shoulder, and the elastomeric base portion running about the base; and
a rigid perimeter below the elastomeric base portion for engaging the powered handpiece.

20. The prophy angle of claim 19 in which the elastomer is a styrene-ethylene-butylene-styrene resin.
